(19) United States
(12) Patent Application Publication
(10) Pub. No.: US 2025/0142680 A1
(43) Pub. Date: May 1, 2025

(54) HEATING SYSTEM

(71) Applicant: Dyson Technology Limited, Wiltshire (GB)

(72) Inventors: Daniel James Bernard SMITH, Newcastle upon Tyne (GB); Barrie Charles MECROW, Newcastle upon Tyne (GB); Mark TURNER, Newcastle upon Tyne (GB)

(21) Appl. No.: 18/689,490

(22) PCT Filed: Sep. 7, 2022
(86) PCT No.: PCT/GB2022/052273

§ 371 Date: Mar. 6, 2024

(30) Foreign Application Priority Data
Sep. 10, 2021 (GB) 2112918.4

(51) Int. Cl. H05B 6/10; A45D 2/00; H05B 6/14

(52) U.S. Cl. CPC H05B 6/103; A45D 2/001; H05B 6/14; H05B 2206/02

(57) ABSTRACT

A heating system is provided. The heating system comprises an induction heating assembly configured to generate a varying magnetic field and a heating target assembly comprising one or more heating targets, wherein the one or more heating targets are moveable relative to the induction heating assembly, the one or more heating targets being heatable by penetration with the varying magnetic field.

### TECHNICAL FIELD

The present invention relates to a heating system for heating an entity. The invention may find particular use in a hair straightening or curling device for heating hair.

### BACKGROUND

Induction heating is a process whereby an electrically conducting object is heated by electromagnetic induction in which a varying/alternating magnetic field is produced. The magnetic field penetrates the electrically conductive object, and induces eddy currents within the object. These eddy currents flow through the object and heat the object via Joule heating. In some examples, the object may also be ferromagnetic, such that additional heat is generated by magnetic hysteresis.

### SUMMARY

According to an aspect of the present invention there is provided a heating system, comprising an induction heating assembly configured to generate a varying magnetic field and a heating target assembly comprising one or more heating targets. The one or more heating targets are heatable by penetration with the varying magnetic field and the one or more heating targets are moveable relative to the induction heating assembly.

Accordingly, the heating system comprises a heating target assembly which can move, or parts of which can move, relative to the induction heating assembly and therefore relative to the magnetic flux generated by the induction heating assembly. Moving one or more heating targets closer or further away from the induction heating assembly can allow the heating of the heating targets to be controlled. As an example, assuming the operation of the induction heating assembly remains constant, a heating target may be moved closer to the induction heating assembly, and the heating target may be heated to a greater extent than when it was located further away from the induction heating assembly. Of course, as will become apparent from the discussion herein, the inverse may sometimes occur, where greater heating is experienced when the heating target moves further away from the induction heating assembly, depending upon the difference between the resonant frequency of the induction system and the drive frequency of the induction heating assembly in each position. Nevertheless, in either case it can be shown that the level of heating (and therefore the temperature of the heating target) can be controlled by controlling the distance between the one or more heating targets and the induction heating assembly.

In some examples, all of the one or more heating targets are moveable but in other examples a subset of the heating targets are moveable, while the remaining heating targets remain in a fixed position relative to the induction heating assembly.

In the above heating system, the heating target assembly is arranged within magnetic proximity of the induction heating assembly to ensure that adequate heating can take place. The heating system may be used to heat an entity such as hair, a fluid, air, liquid, water or foodstuffs, among other examples. Heat is transferred to the entity via the heating target assembly which may be brought within thermal proximity of the entity. In examples, the heating target assembly is a heating plate or a cooking receptacle, such as a pan.

In some examples, the induction heating assembly comprises at least one induction coil. The induction coil may form part of an induction coil assembly comprising a plurality of induction coils, for example. As is known, an induction coil generates a varying/alternating magnetic field when an alternating current passes through the coil. For example, the magnetic field may vary in time and/or in space. In one example the induction heating assembly comprises a drive circuit configured to generate an alternating current of a particular frequency to drive the induction heating assembly (such as the at least one induction coil) to produce the varying magnetic field. The frequency of the alternating current may be known as the drive frequency. In some examples, the drive circuit is configured to supply alternating current at the drive frequency according to a drive signal. A controller may select and/or adjust the drive frequency. In some examples, the induction heating assembly comprises a resonant circuit driven by the drive circuit, where the resonant circuit comprises the at least one induction coil. The resonant circuit may also comprise at least one capacitor. The resonant circuit may be known as an RLC circuit. In an example, the induction coil comprises either part or all of the Resistive (R) and inductive (L) elements of the circuit and the capacitance is provided by an additional capacitor or by self-capacitance within the coil-heating target assembly.

In an example, the heating system is a heating device, such as an induction heating device.

In some examples, the heating target assembly is flexible. The flexible nature of the heating target assembly thereby permits the movement relative to the induction heating assembly. The one or more heating targets therefore form at least part of the flexible heating target assembly. In one example, the heating target assembly comprises a single heating target which can flex/bend. The heating target assembly may therefore be monolithic. In another example, the heating target assembly comprises a plurality of heating targets. For example, the heating target assembly may be articulated or the plurality of heating targets may be embedded within a flexible substrate such as a membrane to permit movement. In some examples, one or more of the plurality of heating targets are rigid, and each target can move relative to a neighbouring heating target. In some examples, one or more of the plurality of heating targets are themselves flexible.

Having a heating target assembly that is flexible allows the heating to be controlled through movement of the one or more heating targets relative to the induction heating assembly while also allowing the heating target assembly to conform to the object being heated. For example, if the heating system forms part of a hair styling device, the heating target assembly can flex/bend due to contact with hair. Conforming to the hair can reduce damage to the hair caused by over compression while also allowing the heat to be distributed more evenly around the hair. Flexing can also cause the hair to gather in a particular place.

In an example, the one or more heating targets are moveable between a first position and a second position, the second position being closer to the induction heating assembly than the first position.

In a particular example, the one or more heating targets are biased towards the first position and are moveable towards the second position. This arrangement may be particularly useful if the one or more heating targets are heated to a greater extent when located in the second position (i.e. closer to the induction heating assembly) because it ensures that the default position undergoes less heating, which can improve safety. For example, if the heating system is part of a hair styling device, the one or more heating targets may be heated to a greater extent when the one or more heating targets are moved closer to the induction heating system via contact with hair and the heating targets are therefore biased towards the first position in absence of the hair. Accordingly, in an example, the one or more heating targets are deflectable towards the second position.

In certain examples, when a region of the heating target assembly is arranged in the first position, the region is heated to a lower temperature than when the region arranged in the second position. The region may include part of a single heating target or one or more heating targets. Accordingly, in a particular arrangement, the heating system may be configured such that greater heating occurs when the region is closer to the induction heating assembly. In some examples, while the region is arranged in the first position, another region of the heating target assembly is arranged in the second position. Thus, different regions of the heating target assembly may be heated to different temperatures simultaneously due to the moveable or flexible nature of the heating target assembly. This again allows greater control over the heating.

A constant or relatively constant temperature can be maintained by selectively controlling the magnetic field. For example, the magnetic field may be switched off when a set temperature is reached, then be switched on again when the temperature falls below this temperature.

In one arrangement, the induction heating assembly is configured to operate at a drive frequency. For example, the induction heating assembly comprises a drive circuit configured to generate an alternating current having a drive frequency to drive the induction heating assembly to produce the varying magnetic field. The drive frequency is selected, by a controller for example, such that the region is heated non-resonantly when arranged in the first position and is heated resonantly when arranged in the second position.

In an example, the region of the heating target assembly and the induction heating assembly form an induction system having: (i) an initial resonant frequency when arranged in the first position, and (ii) a final resonant frequency when arranged in the second position, and the drive frequency is selected such that a difference between the final resonant frequency and the drive frequency is smaller than the difference between the initial resonant frequency and the drive frequency.

As is known, in induction heating systems, perfect resonant heating is achieved when the drive frequency matches the resonant frequency of the induction system.

In the present application, the resonant frequency of the induction system is based on the position of the heating target assembly relative to the induction heating assembly and thus changes depending upon the distance between the heating target assembly and the induction heating assembly. Accordingly, if the drive frequency remains substantially constant as the region of the heating target assembly moves relative to the induction heating assembly, the level of heating can change because the resonant frequency changes (in this case between an initial resonant frequency and a final resonant frequency). To establish resonant heating of the region when the region is located in the second position, the drive frequency can be set so that it substantially matches the final resonant frequency. When the region moves away from the second position, such as back to the first position, the resonant frequency of the induction system changes so that it no longer matches the drive frequency. Thus, non-resonant heating occurs.

In the above example, the drive frequency is said to substantially match the final resonant frequency to cause resonant heating, however, it will be understood that an increased heating effect (i.e. a greater temperature) of the region can still be achieved in the second position compared to the first position by ensuring that the difference between the resonant frequency in the second position and the drive frequency is smaller than the difference between the resonant frequency in the first position and the first drive frequency. Thus, perfect resonance is not necessarily required to achieve the benefits of the invention.

Accordingly, the drive frequency can be selected so that resonant heating occurs when the region of the heating target assembly moves closer to the induction heating assembly. For example, if the heating system is part of a hair styling device, then the device may be configured such that resonant heating occurs when the hair is deflected towards the second (flexed/closer) position. When the hair is removed, the region returns to the first (unflexed/further away) position, and the region is no longer heated resonantly. This means that the presence of hair can cause the induction heating assembly to begin significant heating in that particular region of the heating target assembly. This arrangement can improve the safety of the device by only heating the target(s) to a high temperature when hair is present. This avoids accidental burns or fires should the hair styling device be left switched on.

In the above examples, the drive frequency may remain relatively constant as the heating target assembly moves. This provides a simple way of controlling the degree of heating, but in examples where the heating target assembly is moved/flexed by contact with the entity being heated (discussed in more detail below), this assumes that the heating target assembly will move/flex by the same amount each time if resonant heating is required. However, this may not always be the case. For example, in some circumstances, the heating target assembly may not fully flex, so the resonant frequency does not match the drive frequency and the heating target assembly is heated less efficiently. In addition, each device that is manufactured will have different components and so the resonant frequency and optimal drive frequency will need to be determined for every device. The resonant frequency may also change over time, as components of the device age. To overcome this, in some examples, the drive frequency can be varied or adjusted to ensure that it more closely matches the resonant frequency and in some examples be adjusted to ensure that it matches the resonant frequency regardless of the exact position of the heating target assembly (although in some cases, non-resonant or zero heating may still be desirable when there is no or minimal movement/flex for safety reasons). In some examples, the resonant frequency can be measured, calculated, estimated or inferred. As mentioned above, the resonant frequency is based on the position of the heating target assembly relative to the induction heating assembly and thus changes depending upon the distance between the heating target assembly and the induction heating assembly.

Accordingly, in other examples, the drive frequency may be adjusted/changed as the heating target assembly moves to further control heating. For example, the drive frequency may be adjusted to substantially match the resonant frequency of the induction system regardless of the position of the region of the heating target assembly being heated. This would ensure that the region is heated resonantly at all positions. In other examples, the drive frequency may be adjusted to match the resonant frequency of the induction system based on other factors, such as the presence of the entity (such as hair), the detection of a user input (such as the press of a button) or detecting movement of the device via one or more sensors (such as when a user picks up the device). Accordingly, in some examples, the system further comprises a controller configured to select a drive frequency and cause the induction heating assembly to operate at the selected drive frequency, wherein the controller selects the drive frequency based on the position of the one or more heating targets relative to the induction heating assembly. For example, the controller selects the drive frequency based on the position of a region of the heating target assembly being heated.

The position of the one or more heating targets can be determined or inferred through measurement. As mentioned, the drive frequency may be selected so as to always heat the one or more targets resonantly (i.e. to substantially match the resonant frequency of the region being heated, where the resonant frequency is a function of the position of the region relative to the induction heating assembly). The drive frequency can therefore be varied as the position of the one or more heating targets move relative to the induction heating assembly.

As briefly mentioned, in some examples, at least one of the one or more heating targets are rigid. Having one or more rigid targets may mean that the targets are less prone to breakage. In another example, at least one of the one or more heating targets are flexible. Having one or more flexible heating targets can mean that they conform more closely to the entity being heated, such as hair.

In certain arrangements, in use, the one or more heating targets are moved/moveable due to contact with an entity being heated. The one or more heating targets may therefore not be actively moved by components of the system, but are passively moved via contact with the entity being heated. In an example where the heating system forms part of a hair styling device, the heating target assembly may be brought into contact with hair and the volume of hair causes a region of the heating target assembly to be moved. Thus, the presence of the entity being heated can therefore indirectly control the heating.

In other arrangements, the heating system comprises an adjustment assembly configured to move the one or more heating targets relative to the induction heating assembly. Thus in contrast to the passive movement described above, the adjustment assembly can adjust the position of the one or more heating targets relative to the induction heating assembly as desired. This arrangement can allow the one or more heating targets to be moved without needing to be moved by the entity being heated, thus allowing more direct control over the heating.

In a particular example, the heating system comprises a controller configured to control the adjustment assembly, and thereby movement of the one or more heating targets, based on one or more criteria. For example, the one or more criteria include at least one of: (i) a measured temperature, (ii) a user input received by the heating system, (iii) a time, and (iv) power supply constraints. For example, the temperature of one or more heating targets or the local environment may be measured and the one or more heating targets may be moved to increase or decrease the temperature. In another example, a user might interact with a user interface (such as a button, touch screen, switch etc.) and the user input may result in the position of the one or more heating targets being moved. In another example, the position of the one or more heating targets may be adjusted based on the time of day, the day of the week, the month etc. For example, the heating system may form part of a heater device for heating a room and the heater may be controlled based on the time. In another example, the heating system may be operated based on power supply constraints, such as whether the device is being powered by battery, being powered by a mains supply, is being charged or based on the current charge level of the battery. In this example, the position of the one or more heating targets may be adjusted to compensate for the power supply constraints.

In certain arrangements, the induction heating assembly comprises a top side facing towards the one or more heating targets, and a bottom side facing away from the one or more heating targets, wherein the varying magnetic field is asymmetric such that the magnetic field strength at the top side is substantially greater than the magnetic field strength at the bottom side. In one example, a ratio of the magnetic field strength at the top side to the magnetic field strength at the bottom side is greater than about 100. More preferably, the ratio of the magnetic field strength at the top side to the magnetic field strength at the bottom side is greater than about 1000.

In a particular example, the induction heating assembly comprises an induction coil assembly, and it is the induction coil assembly that has the top side facing towards the heating target assembly, and the bottom side facing away from the heating target assembly.

Accordingly, the induction heating assembly produces a substantially “single-sided” magnetic field in which there is a strong magnetic field produced only at the top side of the induction heating assembly. Preferably there is no magnetic field produced at the bottom side of the induction heating assembly, or the magnetic field strength at the bottom is small or negligible compared to the magnetic field strength at the top side. Thus, a high proportion of the magnetic energy is directed towards the heating target assembly. This asymmetric, or single-sided, magnetic field therefore provides a more energy efficient heating process by reducing the amount magnetic energy being lost in other directions. Energy efficiency is particularly important when the heating system is part of a device that has a battery power source. The single-sided or asymmetric magnetic field may be analogous to a Halbach array of permanent magnets.

In addition, because the magnetic field is directed substantially towards the heating target assembly, the magnetic flux escaping the device can be greatly reduced. This reduces the need for bulky, heavy and expensive magnetic shielding. The device can therefore be made safer, without compromising on size and portability. The use of an asymmetric magnetic field can allow the device to meet certain consumer product safety standards (such as IEC 60335) with no or minimal magnetic shielding. Thus, the use of an asymmetric magnetic field finds particular advantages in a device which is brought into close proximity to a user's head and/or jewelry.

In some arrangements the induction heating assembly comprises a plurality of heating zones, each heating zone being arranged to generate a varying magnetic field to heat a respective region of the heating target assembly. Each heating zone may heat an individual heating target or may heat one or more heating targets. Accordingly, a region might be a region of a single heating target, a single heating target or a plurality of heating targets.

The induction heating assembly may therefore comprise a plurality of heating zones each capable of generating its own magnetic field, such as an asymmetric magnetic field, to heat a particular region of the heating target assembly. Thus, different regions of the heating target assembly can be heated to different temperatures and/or at different times. The use of multiple heating zones therefore improves control. For example, by controlling each heating zone independently, each region of the heating target assembly can be maintained at a particular temperature to avoid heating or overheating other regions.

In an example, each heating zone comprises an induction coil or induction coil assembly. Thus, each heating zone may comprise its own resonant circuit, the resonant circuit comprising the induction coil or induction coil assembly. Similarly, each heating zone may comprise its own drive circuit. Alternatively, a single drive circuit may drive all or at least a plurality of heating zones.

The heating system may further comprise one or more controllers to control operation of the plurality of heating zones. The or each controller may comprise one or more processors, including one or more microprocessors, central processing units and/or graphical processing units, and a set of memory.

In some examples, each heating zone is independently controllable. For example, each heating zone can be driven at different drive frequencies, although in some circumstances one or more heating zones may be independently driven at the same drive frequency at the same time.

In some examples, the induction heating assembly is shaped to correspond to a shape of the heating target assembly. For example, the induction heating assembly may have a curved profile to correspond to a curved profile of the heating target assembly. In a particular example of this, the heating target assembly may be an induction pan/wok, which has a curved base. The heating assembly may then have a curved/“dish” shape to correspond to the curved base. By matching the shape of the induction heating assembly to the heating target assembly, the magnetic field is used more efficiently by ensuring it is focused onto the heating target assembly over the minimum possible average distance.

In some arrangements, the induction heating assembly is flexible. For example, the induction coil(s) can be flexed/manipulated to change shape. The flexible nature can allow the induction heating assembly to match/conform to the shape of the heating target assembly, in some instances, to provide more efficient heating. In a particular example, the heating target assembly may be a saucepan, and the force/weight of the heating target assembly causes the induction heating assembly to flex, thereby substantially conforming to the shape of the heating target assembly. Similarly, the entity being heated may exert a force on the heating target assembly which in turn causes the induction heating assembly to flex. In another example, an adjustment assembly flexes the induction heating assembly.

In a particular example the heating target assembly comprises a plurality of heating targets and each heating zone is arranged to heat at least one heating target of the plurality of heating targets.

In examples, the one or more heating targets each have a thickness of less than about 5 mm or less than about 3 mm, or less than about 2 mm, or less than about 1 mm, or less than about 0.5 mm. In examples, the one or more heating targets may be formed from any suitable electrical conductive material, such as Aluminium, Copper, Steel, Titanium or Beryllium Copper.

In some examples, the heating target assembly comprises a surface that is brought into contact with the entity being heated, such as hair. In an example, the surface is smooth and continuous. However, it may sometimes be useful to limit heat flow along the surface to avoid overheating. Accordingly, in some examples, first and second regions of the heating target assembly are separated by an insulating boundary to reduce heat flow between the first and second regions. In a particular arrangement, the insulating boundary comprises a groove formed in the heating target assembly. The surface of the heating target assembly that contacts the hair may therefore have non-continuous surface.

In some examples, the heating system further comprises a battery power source to power the induction heating assembly.

In a specific example, the heating system is a heating device for heating hair, such as a hair styling device. Hair styling devices can include hair straightening devices used to straighten hair, hair curling devices used to curl hair, hair combing devices to comb hair or hair dryers for drying hair, for example.

In another example, the heating system is a heating device for heating air. The heating device may include a fan to move the air through the heating device and/or environment.

In another example, the heating system is a heating device for heating foodstuffs. For example, the heating device may be toaster or grill, such as a clam-shell grill. In another example, the heating system is an induction cooker where the heating target assembly is a pan or other receptacle that can be moved relative to the induction heating assembly of the cooker. In another example, the heating system is device comprising a griddle plate, where the heating target assembly is the plate that can be moved relative to the induction heating assembly of the device.

Further features and advantages of the invention will become apparent from the following description of preferred embodiments of the invention, given by way of example only, which is made with reference to the accompanying drawings.

### BRIEF DESCRIPTION OF THE DRAWINGS

FIGS. 1A and 1B are schematic diagrams of a heating system comprising a flexible heating target assembly, according to an example;

FIGS. 2A and 2B are schematic diagrams of a heating system comprising an adjustment assembly, according to an example;

FIGS. 3A and 3B are schematic diagrams of a heating system comprising a plurality of heating zones, according to an example;

FIGS. 4A-C are schematic diagrams of heating target assemblies according to various examples;

FIG. 5 is a schematic diagram of an induction heating assembly configured to generate an asymmetric magnetic field, according to an example;

FIG. 6 is a schematic diagram of an asymmetric magnetic field generated by the induction heating assembly of FIG. 5;

FIG. 7 is a schematic diagram of a heating target assembly having a continuous heating surface, according to an example;

FIG. 8 is a schematic diagram of a heating target assembly having insulating boundaries between regions on the heating surface, according to an example;

FIG. 9 is a heat map of the temperature of an example heating target assembly in different regions; and

FIG. 10 is a perspective diagram of a hair straightening appliance, according to an example.

### DETAILED DESCRIPTION

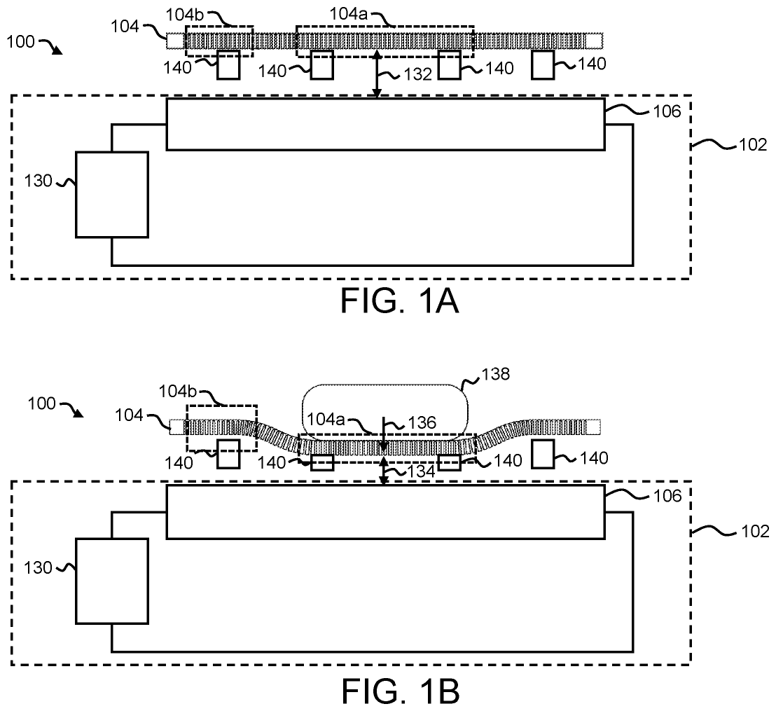

FIGS. 1A and 1B are schematic diagrams of a heating system 100 comprising an induction heating assembly 102 and a heating target assembly 104. In this example, the heating target assembly 104 comprises a single heating target, but in other examples may include one or more heating targets. The heating target assembly 104 of this example takes the form of a flexible heating plate. The heating target assembly 104 is moveable and is arranged in a first configuration in FIG. 1A and a second configuration in FIG. 1B.

When the induction heating assembly 102 generates or is supplied with a high frequency alternating current, the induction heating assembly 102 generates an alternating/varying magnetic field that penetrates the heating target assembly 104. As mentioned, the magnetic field induces eddy currents within the electrically conductive heating target assembly 104 which causes the heating target assembly 104 to heat up. In this example, the induction heating assembly 102 comprises an induction coil assembly 106 comprising one or more induction coils and the induction coil assembly 106 is supplied with the high frequency current to generate the magnetic field. As will be discussed in more detail below, the induction coil assembly 106 has a top side that faces the heating target assembly 104, and a bottom side that faces away from the heating target assembly 104.

To generate and supply the high frequency current, the induction heating assembly 102 comprises a drive circuit 130. The drive circuit 130 is used to provide and control the current flow through the induction coil assembly 106. The alternating current provided to the induction coil assembly 106 by the drive circuit 130 is at a particular frequency, known as the drive frequency. As will be well understood, an induction coil forms part of an induction system that can be driven to resonance, and the induction system therefore has an associated resonant frequency. The induction system includes the induction heating assembly 102 and at least part of the heating target assembly 104. As will be discussed in more detail below, when the drive frequency matches the resonant frequency of the induction system, the heating target assembly 104 can be heated most effectively. Movement of the heating target assembly 104, or regions of the heating target assembly 104, relative to the induction heating assembly 102 causes the resonant frequency of the induction system to change.

In this particular example, the heating target assembly 104 is flexible such that a force applied to the heating target assembly 104 causes the heating target assembly 104 to move/flex. In

FIG. 1A, regions of the heating target assembly 104 are arranged in a first position and the heating target assembly 104 is substantially flat and unflexed. The heating target assembly 104 is arranged at a first distance 132 away from the induction heating assembly 102. In FIG. 1B, a particular region 104a of the heating target assembly 104 is arranged in a second position in which the region has been moved, bent or flexed towards the induction heating assembly 102. This particular region of the heating target assembly 104 is therefore closer to the induction heating assembly 102 in the second position when compared to the first position, and is arranged at a second distance 134 away from the induction heating assembly 102. The second distance 134 is smaller than the first distance 132.

The heating target assembly 104 or regions of the heating target assembly 104 can move from the first position to the second position upon application of a force 136 by an entity 138. In this example, the entity is a volume of hair 138. Upon removal of the hair 138, and therefore the force 136, the heating target assembly 104 is configured to return to the first position depicted in FIG. 1A. One or more biasing members 140, such as springs or resilient members, may urge the heating target assembly 104 back towards the first position. The heating target assembly 104 is therefore biased towards the first position, in this example. A moveable or flexible heating target assembly 104 finds particular use in heater system to control the level of heating of the heating target assembly 104.

In a first example, the heater system 100 is configured such that when a region of the heating target assembly 104 is arranged in the first position (FIG. 1A), the region is heated to a lower temperature than when the region arranged in the second position (FIG. 1B). To achieve this, the drive circuit 130 drives the induction coil assembly 106 at a substantially constant drive frequency as the region of the heating target assembly 104 moves between the first and second positions.

As mentioned above, the induction system has an associated resonant frequency. In some examples, the heating system 100 is made up of a plurality of induction systems with different resonant frequencies, where each induction system includes the induction heating assembly and different flexed/unflexed regions of the heating target assembly 104. FIGS. 1A and 1B show a first region 104a of the heating target assembly 104 and a second region 104b of the heating target assembly 104. In FIG. 1A, the first region 104a and the induction heating assembly 102 form a first induction system having a first initial resonant frequency, and the second region 104b and the induction heating assembly 102 form a second induction system having a second initial resonant frequency. As mentioned, the resonant frequency of the induction systems depends upon the distance between the region 104a, 104b and the induction heating assembly 102, and in particular the induction coil assembly 106. Thus, the resonant frequency of the first induction system is different in FIGS. 1A and 1B. Accordingly, when the first region 104a moves relative to the induction coil assembly 106, the resonant frequency of the first induction system changes, and therefore has a first final resonant frequency. However, because the second region 104b has not moved, or its position has changed very little relative to the induction coil assembly 104, the resonant frequency of the second induction system remains substantially the same as it was in FIG. 1A. The second initial resonant frequency therefore substantially corresponds to the second final resonant frequency.

If the drive frequency of the drive circuit 130 remains constant and is selected to correspond to the first final resonant frequency, the first region 104a will be heated resonantly when it is located in the second position shown in FIG. 1B because the drive frequency substantially matches the resonant frequency of the first region 104a in this position. When the first region 104a is located in the first position shown in FIG. 1A, the resonant frequency (i.e. the first initial resonant frequency) no longer matches the drive frequency such that minimal or no heating occurs. Thus, the drive frequency can be selected such that the region 104a is heated non-resonantly when arranged in the first position and is heated resonantly when arranged in the second position. Thus, the smaller the difference between the drive frequency and the resonant frequency, the greater the region is heated.

Accordingly, the drive frequency may be selected such that the temperature of the heating target assembly 104 in each region is relatively low when arranged in the first position shown in FIG. 1A. The temperature may be below a threshold temperature for example. The temperature may be at a level to avoid serious burns, should a user accidentally touch the heating target assembly 104. The temperature may be at a level to reduce the likelihood of nearby objects being burnt, melted or set on fire, should the device come into contact with the object. For example, the temperature may be below the combustion temperature of common household objects, such as clothing, wood or carpet. The heating target assembly 104 temperature in this unflexed “default” position can be predetermined by a manufacturer by choosing a particular drive frequency.

It will be appreciated that in some instances, as the first region 104a moves, the second region 104b may experience a slight displacement, but the change in resonant frequency of the second induction system may be small or negligible.

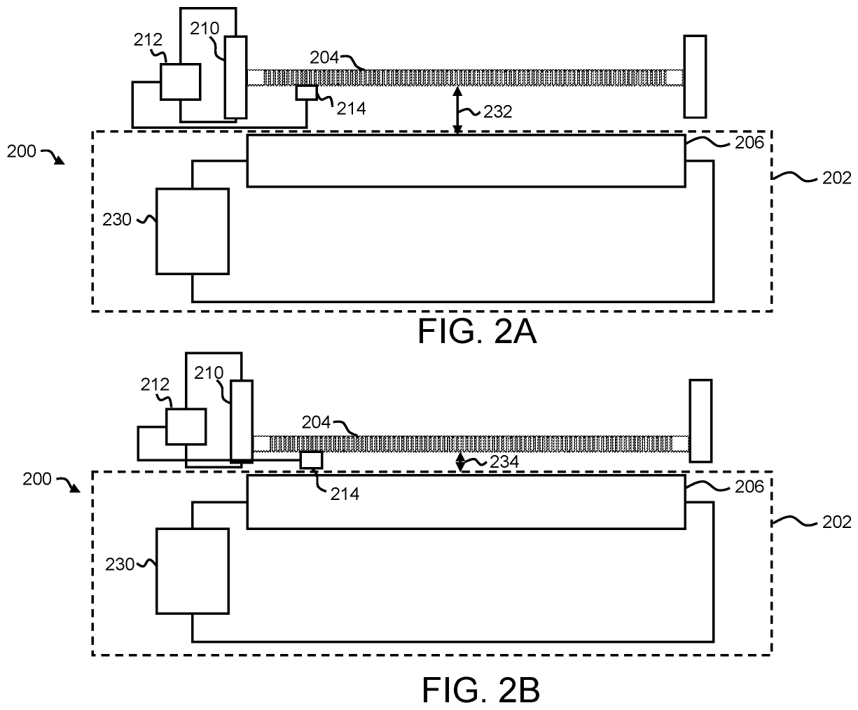

FIGS. 2A and 2B are schematic diagrams of another heating system 200 comprising an induction heating assembly 202 and a heating target assembly 204. In this example, the heating target assembly 204 comprises a single heating target, but in other examples may include one or more heating targets. The heating target assembly 204 of this example takes the form of a rigid heating plate, but in other examples, the heating target assembly 204 may be flexible. The features and operation of the heating system 200 are the same as the heating system 100, but unlike the heating system 100 of FIGS. 1A and 1B, the heating system 200 of this example further comprises an adjustment assembly 210 that moves the heating target assembly 204 relative to the induction heating assembly 202 and therefore relative to the induction coil assembly 206. In some examples, the heating target assembly 204 is also flexible like the example of FIGS. 1A and 1B to provide an additional degree of movement.

In one example, a controller 212 is configured to control the adjustment assembly 210 and thereby movement of the heating target assembly 204 based on one or more criteria, such as a measured temperature, a user input received by the heating system 200, a time and/or power supply constraints. For example, FIGS. 2A and 2B depict a temperature sensor 214 to measure the temperature of the heating target assembly 204 and based on the measured temperature, the controller 212 can adjust the position of the heating target assembly 204.

FIG. 2A shows the heating target assembly 204 arranged in a first position. The heating target assembly 204 is arranged at a first distance 232 away from the induction heating assembly 202. In FIG. 2B, the heating target assembly 204 has been moved towards the induction heating assembly 202 and is arranged in a second position. The heating target assembly 204 is therefore closer to the induction heating assembly 202 in the second position when compared to the first position, and is arranged at a second distance 234 away from the induction heating assembly 202. The second distance 234 is smaller than the first distance 232.

Accordingly, in the same way as described above for heating system 100, the heating target assembly is moveable relative to the induction heating assembly to control the level of heating. For example, the adjustment assembly 210 may be configured to move the heating target assembly 104 from the first position (shown in FIG. 2A) to the second position (shown in FIG. 2B) and the induction heating assembly 204 is heated to a lower temperature in the first position than when it is arranged in the second position.

In some examples, although not depicted, the adjustment assembly 210 is capable of moving one or more regions of the heating target assembly 204, rather than or in addition to moving the whole of the heating target assembly 204. For example, one or more heating targets of the heating target assembly 204 may be moved independently by the adjustment assembly 210. As in the example of FIGS. 1A and 1B, this would allow different regions of the heating target assembly to be heated differently.

In the examples of FIGS. 1A, 1B, 2A and 2B discussed above, the drive frequency may remain the same throughout the heating session (i.e. as the heating target assembly 104, 204 moves/flexes). As mentioned, the resonant frequency of an induction system changes as the heating target assembly 104, 204 moves and may get closer or further away from the drive frequency. This provides a simple way of controlling the level of heating, but assumes that the heating target assembly 104, 204 will move to the desired location each time, which may not always be the case, especially when the movement is being controlled by contact with an entity. For example, in some circumstances, the heating target assembly 104 may not fully flex so the distance 134 is less than is needed to ensure resonant heating. This would mean that the resonant frequency would not match the drive frequency and so the heating target assembly would be heated less efficiently.

To overcome this, in a second example, the drive frequency can be adjusted or “tuned” as the heating target assembly 104, 204 moves to ensure that it matches the resonant frequency more closely. The drive frequency can therefore be selected based on the position of the heating target assembly 104, 204 (or based on the position of a region of the heating target assembly 104, 204) relative to the induction heating assembly 102, 202 as the device is used.

To achieve resonant heating of the heating target assembly 104, 204 or a particular region of the heating target assembly 104, 204, the drive frequency would need to match the resonant frequency of the induction system, but because the resonant frequency dependents on the position of the heating target assembly 104, 204, it would need to be determined for each position.

In some examples, the resonant frequency at a particular position and moment in time can be determined/calculated by measuring the current and/or voltage at certain locations within the circuit and inputting these parameters into well known, standard equations. Once the resonant frequency is known, the drive circuit 130, 230 can adjust the drive frequency to match the determined resonant frequency. If the position of the heating target assembly 104, 204 moves again, the same process can be repeated so that the drive frequency is adjusted as the heating target assembly 104, 204 moves. A controller can determine the resonant frequency and therefore the drive frequency and responsively cause the induction heating assembly 102, 202 to operate at the selected drive frequency.

Alternatively, rather than determining the resonant frequency through measurement of the circuit parameters, the resonant frequency may be obtained from a lookup table based on a measured position of the heating target assembly 104, 204 being heated. For example, one or more light sensors (not shown) may measure the distance 134, 234 between the heating target assembly 104, 204 and the induction heating assembly 102, 202. Based on a previous calibration or calculation, specific measured distances may correspond to specific resonant frequencies and therefore specific drive frequencies. A lookup table stored in memory of a controller may store an association between the measured distances and the resonant frequencies and/or drive frequencies, so that the desired drive frequency can be selected to resonantly heat the heating target assembly 104, 204. If the position of the heating target assembly 104, 204 moves again, the same process can be repeated so that the drive frequency is adjusted as the heating target assembly 104, 204 moves. A controller can determine the resonant frequency and therefore the drive frequency and responsively cause the induction heating assembly 102, 202 to operate at the selected drive frequency.

Accordingly, the systems 100, 200 of FIGS. 1A, 1B, 2A and 2B may be controlled via either method.

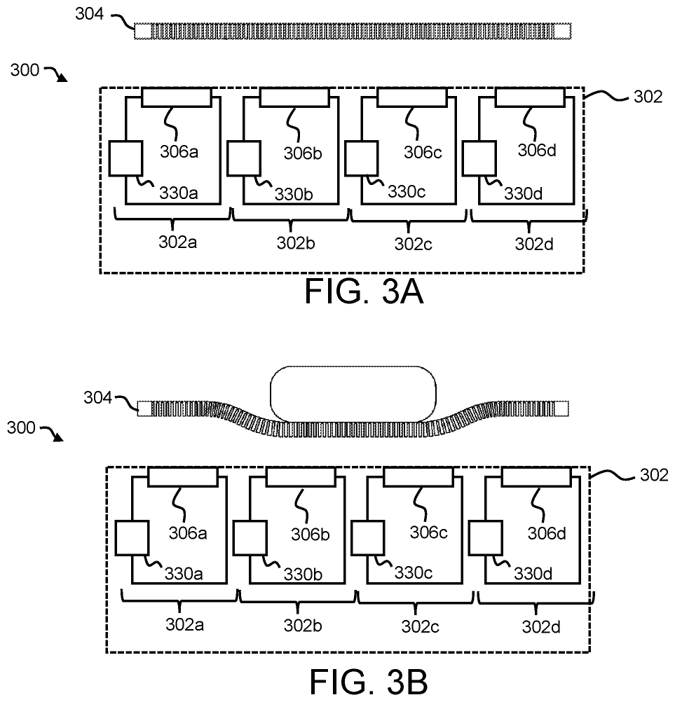

FIGS. 3A and 3B depict another heating system 300 comprising an induction heating assembly 302 comprising a plurality of heating zones 302a-d, where each heating zone 302a-d is arranged to generate a varying magnetic field to heat a respective region of the heating target assembly 304. The magnetic field from each inductor coil assembly 306a-d is directed towards a particular region/area of the heating target assembly 304 to primarily heat that particular region.

In the example of FIGS. 3A and 3B, there are four heating zones 302a-d, each comprising an inductor coil assembly 306a-d and a drive circuit 330a-d. Each heating zone 302a-d is therefore individually controllable. A single controller may control each heating zone 302a-d or a plurality of controllers may control the heating zones 302a-d. In this example, each heating zone 302a-d comprises its own controller to control the heating zone 302a-d. The controller(s) may control the drive frequency of the drive circuits 330a-d and/or control when the heating zone 302a-d is operative. In some examples, a single drive circuit may drive all of the inductor coil assemblies 306a-d.

In FIG. 3A, the heating target assembly 304 is arranged in a first position and the drive circuit 330a-d of each heating zone 302a-d drives each inductor coil assembly 302a-d at a particular drive frequency. For example, a first heating zone 302b is driven at a first drive frequency and a second heating zone 302a is driven at a second drive frequency.

As mentioned above, each heating zone 302a-d and the respective region of the heating target assembly 304 being heated by the heating zone 302a-d is part of a separate induction system having a particular resonant frequency based on the position of the heating target assembly 304 being heated by the heating zone 302a-d.

In contrast to the examples in FIGS. 1A, 1B, 2A and 2B, the heating of each region of the heating target assembly 304 can be controlled to a greater extent because each region is being heated by a different heating zone 302a-d. This means that certain regions may be heated differently by adjusting the drive frequency of the heating zones 302a-d. For example, the first heating zone 302b may heat a first region of the heating target assembly 304 and the second heating zone 302a may be switched off (at least temporarily) so as not to heat a second region of the heating target assembly 304. Due to heat flow along the heating target assembly 304, the second region may still be heated, but this method of operation may be more energy efficient than operating all heating zones 302a-d at once. In another example, it may be desirable to heat the centre zones 302b, 302c to a higher temperature than the end zones 302a, 302d so these centre zones 302b, 302c may be heated resonantly, while end zones 302a, 302d are heated non-resonantly. Other modes of operation are possible. As such, it can be seen that different control schemes can be utilized by having a plurality of heating zones.

In some examples, some or all of the heating zones 302a-d may be operated with a fixed drive frequency as discussed above. In other examples, some or all of the heating zones 302a-d may be operated with a variable drive frequency to fine tune the drive frequency. In one example, the heating target assembly 304 is not moveable/flexible, so its position may be fixed relative to the induction heating assembly 302.

In some examples, the systems 100 and 200 of FIGS. 1A, 1B, 2A and 2B may be modified to include a plurality of heating zones. Accordingly, the features and control methods discussed in relation to FIGS. 1A, 1B, 2A and 2B also apply to FIGS. 3A and 3B.

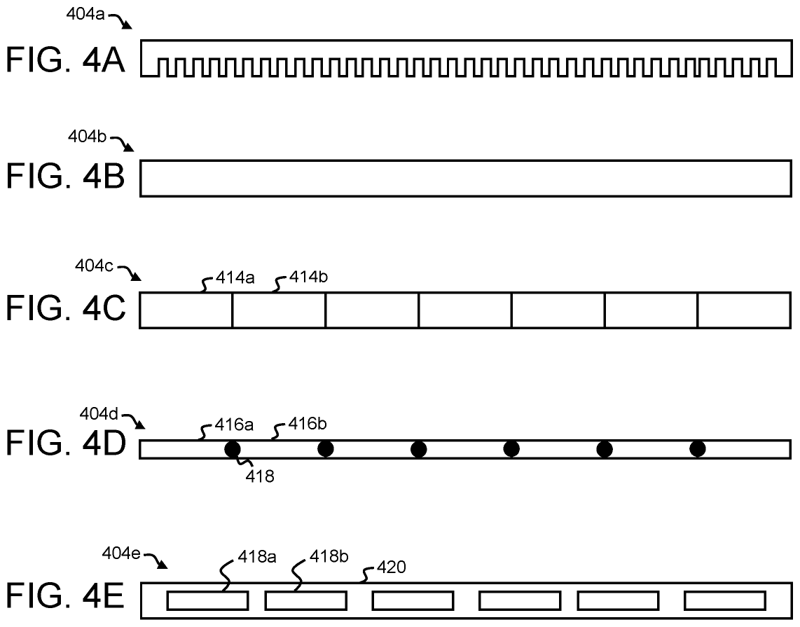

FIGS. 4A-4E depict various types of moveable and/or flexible heating target assemblies. Each heating target assembly comprises one or more heating targets that are heatable by penetration with a magnetic field. The example heating target assemblies of FIGS. 4A-4E may be incorporated into any of the heating systems described above.

FIG. 4A depicts a first heating target assembly 404a comprising a single heating target and is therefore monolithic. In this example, the heating target assembly is flexible. To aid or achieve the flexibility, the heating target assembly 404a comprises a series of notches or grooves along at least one surface.

FIG. 4B depicts a second heating target assembly 404b comprising a single heating target and is therefore monolithic. In this example, the heating target assembly is rigid and can be moved by an adjustment assembly.

FIG. 4C depicts a third heating target assembly 404c comprising a plurality of heating targets 414a, 414b. In this example, the heating target assembly is rigid and can be moved by an adjustment assembly. In an alternative example, the individual heating targets are themselves flexible so that the heating target assembly 404c can flex. In some examples, the heating targets are made from the same material (possibly with the same or different thicknesses), but in other examples at least one heating target is made of a material that is different to another heating target. Different materials may have different resonant characteristics, and so may behave differently when penetrated with a magnetic field. In some examples, the materials may have different resonant characteristics by having different thicknesses.

FIG. 4D depicts a fourth heating target assembly 404d comprising a plurality of heating targets 416a, 416b. In this example, the heating target assembly is flexible/articulated due to pivoting joints 418 connecting the heating targets 416a, 416b. In some examples, some or all of the heating targets 416a, 416b are rigid, but in other examples some or all of the heating targets are flexible. In some examples, the heating targets are made from the same material, but in other examples at least one heating target is made of a material that is different to another heating target.

FIG. 4E depicts a fifth heating target assembly 404e comprising a plurality of heating targets 418a, 418b. In this example, the heating target assembly is flexible due to the heating targets 418a, 418b being embedded within a flexible substrate 420. In some examples, some or all of the heating targets 418a, 418b are rigid, but in other examples some or all of the heating targets are flexible. In some examples, the heating targets are made from the same material, but in other examples at least one heating target is made of a material that is different to another heating target.

In some examples of the invention, the magnetic field generated by the induction heating assembly is asymmetric, meaning that the magnetic field strength at the top side of the induction heating assembly (i.e. the induction coil assembly) is substantially greater than the magnetic field strength at the bottom side. Thus, a greater percentage of the magnetic flux impinges the heating target assembly when compared to a symmetric magnetic field.

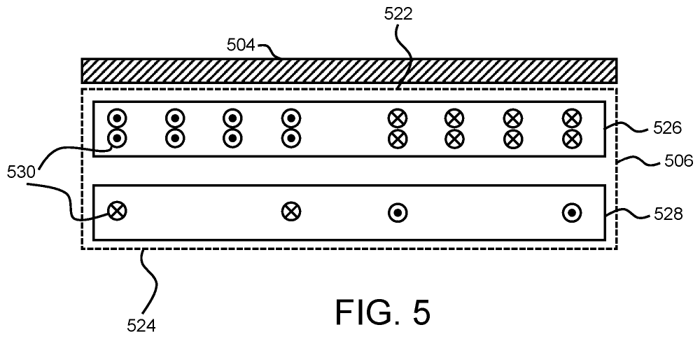

The particular induction heating assembly depicted in FIG. 5 generates an asymmetric magnetic field and comprises an induction coil assembly 506 having a number of windings of a conductor 530. In this example, the conductor 530 is a litz wire comprising a plurality of twisted wire strands. As is well known, a litz wire is designed to reduce high frequency AC losses, such as skin and proximity effects within the conductor. To achieve the asymmetric magnetic field, the induction coil assembly comprises a power coil layer 526 and a screening coil layer 528. In general terms, the power coil layer 526 is designed to generate a sufficiently strong magnetic field to heat the heating target assembly 504, and the screening coil layer 528 is designed to generate an opposing magnetic field to cancel out or sufficiently reduce the magnetic flux passing out of the bottom side 524 of the induction heating assembly. At any point along the induction coil assembly 506, the current passing through the conductor windings in the screening coil layer 528 is opposite to the current passing through the conductor windings in the power coil layer 526. The current flowing in the opposite direction in the screening coil layer 528 creates an opposing magnetic field.

In FIG. 5, the power coil layer 526 comprises two layers of four windings of a single conductor 530 which form a spiral shape when viewed from above. The conductor 530 is therefore wound into and out of the page. In windings where the current flows out of the page at an instance in time, the conductor 530 is shown illustrated with a dot in its centre. In windings where the current flows into the page at the same instance in time, the conductor 530 is shown with a cross. It will be understood that the current is alternating, so the direction of the current is reversed in accordance with a drive frequency. The screening coil layer 528 comprises one layer of two windings of the same conductor 530. To ensure that the magnetic field is asymmetric, the current density in the power coil layer 526 is greater than the current density in the screening coil layer 528. The magnetic field created by the power coil layer 526 is therefore stronger than the magnetic field created by the screening coil layer 528. The form of the magnetic field can be adjusted by altering the current density and/or positions of the conductors 530 in each layer 526, 528. Accordingly, it will be appreciated that the number of windings in each coil layer 526, 528 may be different to that illustrated in FIG. 5.

In this particular example, a single conductor 530 forms both the power coil 526 and the screening coil layer 528. In other examples, two or more conductors may be used. For example, a single conductor may form the power coil layer 526 and a different conductor may form the screening coil layer 528. In some examples, two or more conductors may be used within each layer 526, 528.

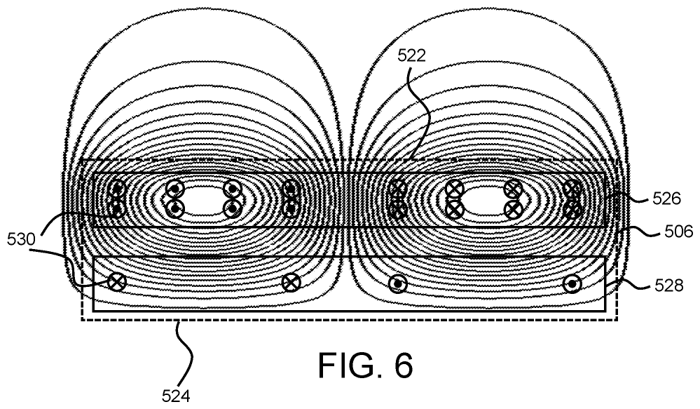

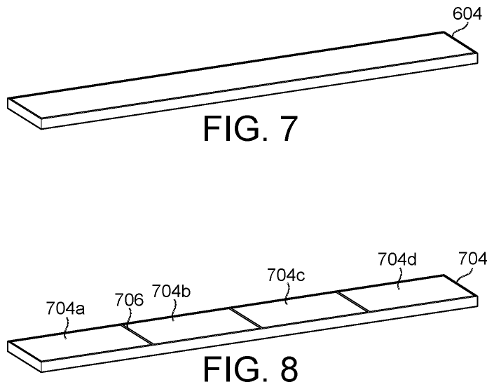

FIG. 6 depicts an example asymmetric magnetic field generated by the induction heating assembly of FIG. 5. The heating target assembly 504 is omitted so that the single sided nature of the magnetic field is more clearly visible. Introducing the heating target assembly 504 would distort the magnetic field from that shown in FIG. 6 (particularly in the top side 522) as the magnetic flux is absorbed by the heating target assembly 504.

The magnetic fields generated by the power coil layer 526 and the screening coil layer 528 combine to produce an overall asymmetric magnetic field which has a magnetic field strength at the top side 522 of the induction coil assembly 506 that is substantially greater than the magnetic field strength at the bottom side 524. Visually, this asymmetric magnetic field is shown by no, or a reduced number of magnetic field lines extending beyond the bottom side 524 of the induction coil assembly 506. As such, a high proportion of the magnetic energy is directed towards the induction heating target assembly 504 and the magnetic flux escaping the device is greatly reduced. Having an asymmetric magnetic field means that magnetic shielding within the device can be omitted or reduced in thickness.

The example induction coil assembly 506 and therefore the generated asymmetric magnetic field can be incorporated into any of the heating systems 100, 200, 300 discussed above. For example, in FIGS. 3A and 3B, one or more of the heating zones 302a-d may incorporate the induction coil assembly 506 of FIGS. 5 and 6.

As discussed above, some regions of the heating target assembly may be heated to a greater extent than other regions, either due to movement of the region, the use of a plurality of heating zones and/or use of different materials with different resonant characteristics. In some examples, it may be useful to limit heat flow between adjacent regions. Therefore, in some examples, a surface of the heating target assembly may have one or more insulating boundaries separating different regions on the heating target assembly to reduce heat flow between regions. FIG. 7 depicts a heating target assembly 604 without insulating boundaries, whereas FIG. 8 depicts an insulating boundary 706 between each region. For example, FIG. 8 depicts an insulating barrier 706 separating the first and second regions 704a, 704b. In this particular arrangement, the insulating boundary is a groove formed on the heating target assembly such that the surface of the heating target assembly that contacts the entity being heated, such as hair, may have a non-continuous surface. The groove may be integrally formed, or may be etched or milled from the heating target assembly 704. Insulating boundaries may be incorporated into any of the heating target assemblies described above.

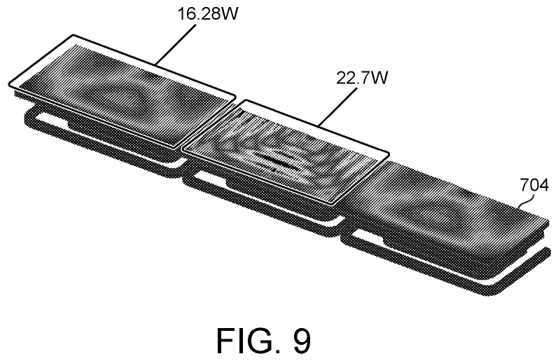

FIG. 9 depicts a heat map of the surface of an example heating target assembly having three heating zones that heats three respective regions on the heating target assembly 704. In a particular example, the central region may be arranged in the second, flexed position and is thus being heated resonantly. The temperature of the heating target assembly 704 in this central region is therefore higher than that of the two adjacent regions which remain unflexed and separated by insulating boundaries.

As briefly mentioned throughout, the heating systems described above may be incorporated into a wide variety of devices/appliances. In one example, the heating system forms part of a hair styling device, such as a hair straightening device.

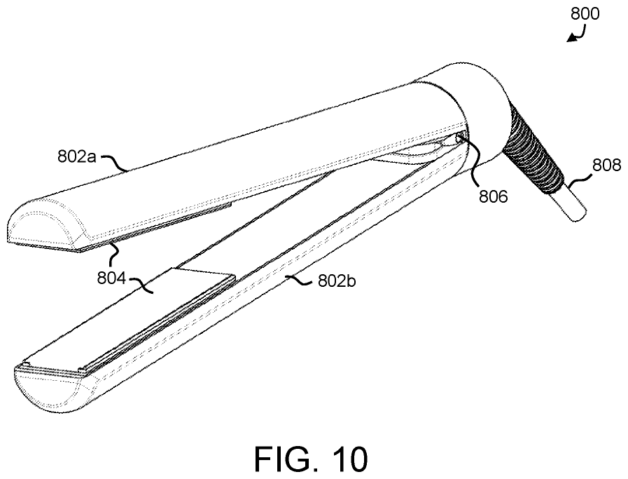

FIG. 10 is a perspective view of an example hair straightening device 800 comprising a first arm 802a and a second arm 802b, which are joined together at one end by a hinge 806. A power supply cable 808 extends away from the hinged end of the hair straightening device 800. In other examples, the hair straightening device 800 comprises an internal battery power source, such that the power supply cable 808 is omitted.

Each arm 802a, 802b comprises a heating target assembly 804 located towards the end of the arm furthest away from the hinge 806. Inside each arm is an induction heating assembly to heat the heating target assembly 804. FIG. 10 shows the hair straightening device 800 in an open position where the heating target assemblies 804 are spaced apart. The heating target assemblies 804 are arranged to contact each other when the first and second arms 802a, 802b are brought together by a user into a closed position. The heating target assemblies 804 comprise a hair contacting surface which contacts hair, in use. Hair that is to be straightened is trapped between the two heating target assemblies 804 and heat is transferred to the hair from the heating target assemblies 804.

The above examples are to be understood as illustrative. Further examples are envisaged. Any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

1. A heating system, comprising:
an induction heating assembly configured to generate a varying magnetic field; and
a heating target assembly comprising one or more heating targets, wherein the one or more heating targets are moveable relative to the induction heating assembly, the one or more heating targets being heatable by penetration with the varying magnetic field.

2. The heating system according to claim 1, wherein the heating target assembly is flexible.

3. The heating system according to claim 1, wherein the one or more heating targets are moveable between a first position and a second position, the second position being closer to the induction heating assembly than the first position.

4. The heating system according to claim 3, wherein the one or more heating targets are:
biased towards the first position; and
moveable towards the second position.

5. The heating system according to claim 3, wherein when a region of the heating target assembly is arranged in the first position, the region is heated to a lower temperature than when the region arranged in the second position.

6. The heating system according to claim 5, wherein:
the induction heating assembly is configured to operate at a drive frequency; and
the drive frequency is selected such that the region is heated non-resonantly when arranged in the first position and is heated resonantly when arranged in the second position.

7. The heating system according to claim 6, wherein:
the region of the heating target assembly and the induction heating assembly form an induction system having: (i) an initial resonant frequency when arranged in the first position, and (ii) a final resonant frequency when arranged in the second position; and
the drive frequency is selected such that:
a difference between the final resonant frequency and the drive frequency is smaller than the difference between the initial resonant frequency and the drive frequency.

8. The heating system according to claim 1, 4, further comprising a controller configured to select a drive frequency and cause the induction heating assembly to operate at the selected drive frequency, wherein:
the controller selects the drive frequency based on the position of the one or more heating targets relative to the induction heating assembly.

9. The heating system according to claim 2, wherein at least one of the one or more heating targets are rigid.

10. The heating system according to claim 2, wherein at least one of the one or more heating targets are flexible.

11. The heating system according to claim 1, wherein, in use, the one or more heating targets are moved due to contact with an entity being heated.

12. The heating system according to claim 1, further comprising an adjustment assembly configured to move the one or more heating targets relative to the induction heating assembly.

13. The heating system according to claim 12, further comprising a controller configured to control the adjustment assembly, and thereby movement of the one or more heating targets, based on one or more criteria.

14. The heating system according to claim 13, wherein the one or more criteria include at least one of:
a measured temperature;
a user input received by the heating system;
a time; and
power supply constraints.

15. The heating system according to claim 1, wherein the induction heating assembly comprises a top side facing towards the one or more heating targets, and a bottom side facing away from the one or more heating targets, wherein the varying magnetic field is asymmetric such that the magnetic field strength at the top side is substantially greater than the magnetic field strength at the bottom side.

16. The heating system according to claim 1, wherein the induction heating assembly comprises a plurality of heating zones, each heating zone being arranged to generate a varying magnetic field to heat a respective region of the heating target assembly.

17. The heating system according to claim 16, wherein each heating zone is independently controllable.

18. The heating system according to claim 1, wherein the induction heating assembly is shaped to correspond to a shape of the heating target assembly.

19. The heating system according to claim 18, wherein the induction heating assembly has a curved profile to correspond to a curved profile of the heating target assembly.

20. The heating system according to claim 1, wherein the induction heating assembly is flexible.
